(19) United States
(12) Patent Application Publication
(10) Pub. No.: US 2008/0252096 A1
(43) Pub. Date: Oct. 16, 2008

(54) Blind Arrangement

(75) Inventor: Tobias Mueller, Muenchen (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/576,292

(22) PCT Filed: Sep. 23, 2005
(86) PCT No.: PCT/DE05/01689

§ 371 Date: Jan. 8, 2008

(30) Foreign Application Priority Data
Sep. 29, 2004 (DE) 10 2004 047 393.5

(51) Int. Cl. B60J 1/20; B60J 7/00

(52) U.S. Cl. 296/143

(57) ABSTRACT

A shade arrangement for a motor vehicle with a drive unit which has a roller tube for taking up a shade, a roller shaft, an electric motor for driving the roller tube around the roller shaft, and a planetary gearing, the inner surface of the roller tube being formed as a ring gear of the planetary gearing. The electric motor has a stator and an armature, the stator being connected to the roller tube and stator turns with it, and the armature turns relative to the vehicle body when the roller tube turns. The electric motor can have sliding contacts by means of which it is connected to the voltage source of the vehicle. Alternatively, the electric motor is connected by means of flexible cables to a body-mounted voltage source of the vehicle. Furthermore a slip clutch can be provided in the drive line of the roller tube.

### BACKGROUND OF THE INVENTION

1. Field of Invention

This invention relates to a shade arrangement for a motor vehicle with a drive unit which has a roller tube for taking up a length of shade material, a roller shaft and an electric motor for driving the roller tube around the roller shaft, and planetary gearing. In particular, the present invention relates to such a shade arrangement in which the electric motor has a stator and an armature, the stator being connected to the roller tube such that, when the roller tube turns, the stator turns with it, and the armature being supported such that it turns relative to the vehicle body when the roller tube turns.

2. Description of Related Art

Electric motors for driving shade arrangements or window roller blinds which generally drive a roller shaft via gearing are known from various documents. German Patent Application DE 30 24 358 A1 describes a tube motor with a planetary gearing for driving a roller blind. In operation, the stator of the tube motor remains stationary and the turning armature drives a driving disk which turns the roller shaft of the roller blind in turn. In German Patent Application DE 35 39 513 A1, a tube motor with a planetary gearing drives the roller shaft of a vehicle window shade, the shade being inserted in a sleeve which likewise holds a step-down gearing. Here, only the armature of the motor is turned. German Patent Application DE 102 14 434 A1, conversely, discloses a tube motor for driving roller blinds, awnings, shades and gates in which the housing of the tube motor, for driving, is turned together with a roller shaft onto which, for example, a web of fabric can be taken up, against a stationary end cap. The use of certain gearing and other details on the electric motor are not shown here. The indicated shade arrangements have the disadvantage that, on the one hand, they require a comparatively large installation space for use in a motor vehicle, and on the other hand, due to their large number of components, they are relatively expensive and time-consuming to produce or install in a vehicle.

### SUMMARY OF THE INVENTION

Thus, a primary object of this invention is to devise a shade arrangement for motor vehicles of the initially mentioned type in which both an economical design with as few components as possible and which requires only a small installation space can be achieved.

This object is achieved by shade arrangements described herein below. In a shade arrangement according to the invention the roller tube for taking up the length of shade material has an inside surface that is made as a ring gear of a planetary gearing by which a roller shaft is driven by an electric motor. By making the inside surface of the roller tube a ring gear of the planetary gearing, thus, the planet wheels of the planetary gearing run on the cylindrical inner surface of the roller tube which preferably have corresponding teeth or grooves along the lengthwise direction of the roller tube. Furthermore, making the cross section of the roller tube as a ring gear has the great advantage that an additional ring gear need not be installed into the roller tube and supported, by which considerable space is saved. Also, by eliminating an additional ring gear, production is simplified, and thus, also more economical.

In a preferred embodiment of this invention, the sun wheel of the planetary gearing is driven by the electric motor and output driving of the planetary gearing takes place via a planet carrier. In another preferred embodiment of this invention, the planetary gearing is made in several stages, i.e., several planetary gears are connected in succession. In such a multistage arrangement, preferably, the planet carrier of a preceding gear stage is connected to the sun wheel of a following gear stage. Output driving from the entire gear arrangement takes place via the planet carrier. When using such multistage gearing, preferably, the inner surface of the roller tube is used for all planetary stages as a common ring gear. In this connection, in turn, the inner surface of the ring gear is structured, at least in the region of the different gear stages along the roller tube, such that the roller tube has a cross section which corresponds to that of the ring gear.

In a shade arrangement according to another aspect of the invention, the electric motor itself comprises a stator (often also called a “frame” or “exciter”) and an armature (i.e., a “rotor” or “inductor”), the stator being connected to the roller tube such that when the roller tube turns, the stator turns with it. In preferred embodiments of this invention, the stator can have permanent magnets which are preferably cemented to the roller tube. The armature of the electric motor is supported such that it turns relative to the vehicle body when the roller tube turns. Since both the stator and also the armature of the electric motor move relative to the vehicle body when the roller tube is moved, the electric motor of the invention has sliding contacts by means of which it is connected to the voltage source of the vehicle. In an especially preferred version of this invention, the sliding contacts of the electric motor contain a body-mounted brush system which connects the voltage source of the vehicle to a commutator of the armature of the electric motor. Here, it is especially advantageous if the brush system of the electric motor, which is generally necessary for an electric motor with a current-carrying armature, is also used to form the sliding contact of the electric motor which turns at the same time as the roller tube towards the body.

In accordance with another feature of the shade arrangement of the invention, the electric motor for driving the roller tube around the roller shaft is connected to the roller tube by the stator such that the stator turns at the same time with the roller tube when the latter turns and the armature of the electric motor is also supported here such that it turns when the roller tube is turned relative to the vehicle body. According to the invention, the electric motor is connected by means of flexible cables to the voltage source of the vehicle, the length and flexibility of the cables being selected such that even for the maximum rotary path of the electric motor, the connection to the voltage source is preserved. This means that, when the shade of the shade arrangement is unwound by turning the electric motor, its cable is turned, their material properties being selected such that they cannot tear or be damaged even at the maximum withdrawal path of the length of shade. Preferably, the housing contains the stator of the electric motor within which, in turn, the armature is pivotally supported, and preferably, is electrically connected to the flexible cables via a corresponding brush system.

In accordance with another feature of the shade arrangement of the invention, the drive unit has a roller tube for taking up the shade and an electric motor for driving the roller tube, and in the drive line of the roller tube, there is a slip clutch which is used to prevent overloading of the drive line by, for example, the slip clutch being able to slip when the shade arrangement is blocked.

In a preferred embodiment of the invention, the slip clutch has two clutch disks which are in contact with one another and which are pretensioned against one another. Preferably, the electric motor is supported against one of the two clutch disks and the other clutch disk is connected to the vehicle body. In other embodiments of this invention, the clutch disks are arranged such that they can be turned relative to one another once a a predetermined torque is applied.

Alternative embodiments of the invention which can be implemented are explained below.

In preferred embodiments of the aforementioned invention, the roller tube is made in several parts and has partial tubes which, together with the round housing of the electric motor, form the roller tube. Preferably, the partial tubes can be slipped onto the electric motor so that the surface of the partial tubes together with the surface of the round housing of the electric motor forms a roller surface for the shade. However, alternatively, the roller tube can also be made in one piece and the electric motor can be inserted into the roller tube. Both in these described embodiments of one-piece and in multi-piece roller tubes, an especially space saving design can be achieved by installation of the electric motor in the roller tube. In especially preferred embodiments with a one-piece roller tube, the roller tube itself can form the housing of the electric motor. Since, in this connection, a complete electric motor is not inserted into the roller tube, but only the electric motor without the housing, the space requirement can thus be further reduced.

Preferably, all of these embodiments can have an end cap on one side of the roller tube, the end cap, in turn, containing an inner part which is pivotally supported relative to the roller tube and is connected to the vehicle body on its side facing away from the roller tube. The part of the end cap which is permanently connected to the roller tube can have a cylindrical section onto which the roller tube is slipped, and furthermore a conical cable drum for taking up the cable which pulls out the length of shade.

In other preferred versions, the roller shaft which is driven by the electric motor, on the side of the roller tube which faces away from the end cap, projects out of the roller tube and is supported on the body. Thus, the roller tube has a body-mounted bearing on both sides (roller shaft, on the one hand, and end cap, on the other) around which it turns when the shade is being rolled up or unrolled. One preferred version of the invention is achieved by the sliding contacts being housed within the end cap in versions with sliding contacts, by which in turn the required installation space is reduced. A shade arrangement according to the invention can also have at least one sensor, preferably a Hall sensor, which is made such that it can determine the rotational position of the roller tube.

In embodiments of the invention with a slip clutch, the provision of a rotational position sensor is preferably assigned to the roller tube, but in embodiments without a slip clutch, the sensor is advantageously assigned to the armature of the electric motor. Together with corresponding read-out electronics, the signals of the sensors can be used, for example, to fix the rotary path of the roller tube, and thus, the extension length of the shade. As a result, pre-selected extension lengths of the shade can be automatically obtained. This sensor can also be housed within the end cap in embodiments with an end cap.

The invention is explained by way of example below using the drawings.

### BRIEF DESCRIPTION OF THE DRAWINGS

FIG. 1 is a perspective view of a cut-open shade arrangement in accordance with the invention, in which the electric motor is connected by means of flexible cable;

FIG. 2 shows the shade arrangement from FIG. 1 in the closed state;

FIG. 3 is a perspective view of a shade arrangement with a one-piece roller tube;

FIG. 4 is a perspective view of a cut-open shade arrangement with an electric motor with sliding contacts; and

FIG. 5 is an enlarged sectional of a portion of the shade arrangement from FIG. 4 in the area of the electric motor.

### DETAILED DESCRIPTION OF THE INVENTION

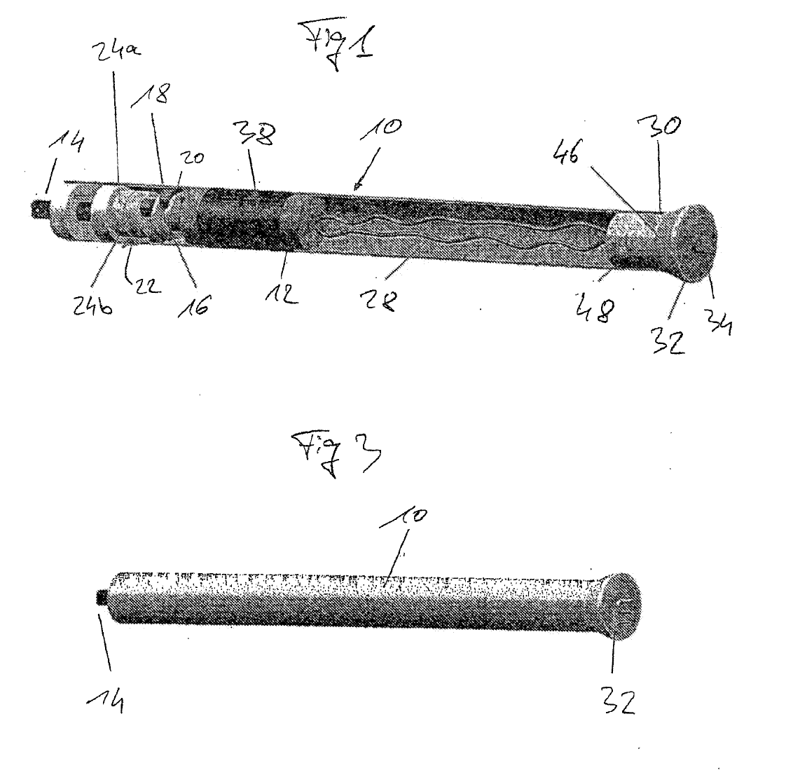

FIG. 1 shows a shade arrangement for a motor vehicle in accordance with the invention. The shade arrangement has a roller tube 10 which is driven by an electric motor 12. The electric motor 12 has an external cylindrical housing 38 which is part of the roller tube 10. The motor 12 drives the roller tube 10 via a planetary gearing 16 by the motor 12 being supported via the planetary gearing 16 relative a motor-side clutch disk 24b of a slip clutch 22. The clutch disk 24b engages a body-side clutch disk 24a of the slip clutch 22 which is fixed on the vehicle body via the roller shaft 14. The planetary gearing 16 is used to step down the comparatively high motor rpm, which is, conventionally, about 2000 to 10000 rpm, to a rpm of the roller tube 10 of roughly 20 to 100 rpm. In the embodiment of the invention shown here, the planetary gearing 16 is three-stage gearing so that, altogether, three planet carriers 20 bear three planet wheels 18.

Driving of the planetary gearing 16 by the electric motor 12 takes place via a sun wheel which cannot be seen here. The output driving from the planetary gearing 16 takes place via the last of the three planet carriers which is permanently connected to the motor-side clutch disk 24b. In accordance with the invention, all planet wheels 18 run in a ring gear which is formed by the inner surface of the roller tube 10. Therefore, roller tube 10 has corresponding teeth on its inner surface (not shown in the figure) which extend at least over the region of the roller tube which is in the path of the planet wheels 18 around the axis of rotation of the roller shaft 14. The teeth are made such that a transverse cross section through the roller tube 10 in the plane of the planetary wheels 18 yields a ring gear.

Therefore, in operation of the shade arrangement, when the shade which has been wound at least partially on roller tube 10 is extended or retracted, the electric motor 12 turns at its motor rpm. This motor rpm is converted by the planetary gearing 16 into the desired rpm of the roller tube 10, the planetary gearing being supported indirectly via the roller shaft 14 on the body of the vehicle. Thus, both the housing 38 of the electric motor 12 and also the armature of the electric motor (not shown here), which motor drives the planetary gear 16, turn relative to the vehicle body. To supply electric current to the rotating electric motor 12, the motor is connected to a voltage source in the vehicle by the cables 28. The cables 28 are chosen with respect to their flexibility and length such that rotation of the electric motor 12 around the body-mounted roller shaft 14 from the initial position with the shade taken completely up to an end position with the shade completely unwound is possible without the cables 28 themselves or the electrical connection from the motor to the battery being interrupted. The cables 28 are routed for this purpose through an end cap 30 which has a cylindrical part 48 with which it is slipped onto the roller tube 10. The end cap 30 has an inner part 32 which is pivotally mounted in it and which is connected to the vehicle body via a journal 34. Furthermore, the end cap 30 has a cone-shaped cable drum 46 onto which a cable which draws the shade can be taken up or slides it on in a compressively stiff design of the cable; see, e.g., commonly-owned, co-pending U.S. patent application Ser. No. 11/576,092.

FIG. 2 shows a view of the shade arrangement from FIG. 1 in the closed state of the roller tube 10. As already explained above, the roller tube 10, on the one hand, is formed by housing 38 of the electrical motor 12 and by two tube segments 36a, 36b, which have the same outside diameter as the housing 38 of the electric motor 12. The two tube segments 36a, 36b can be, for example, slipped onto the electric motor 12. The journals 34 of the end cap 30 and a corresponding journal 35 of the roller shaft 14, which constitute the body-mounted anchors of the drive unit, project out of the roller tube 10.

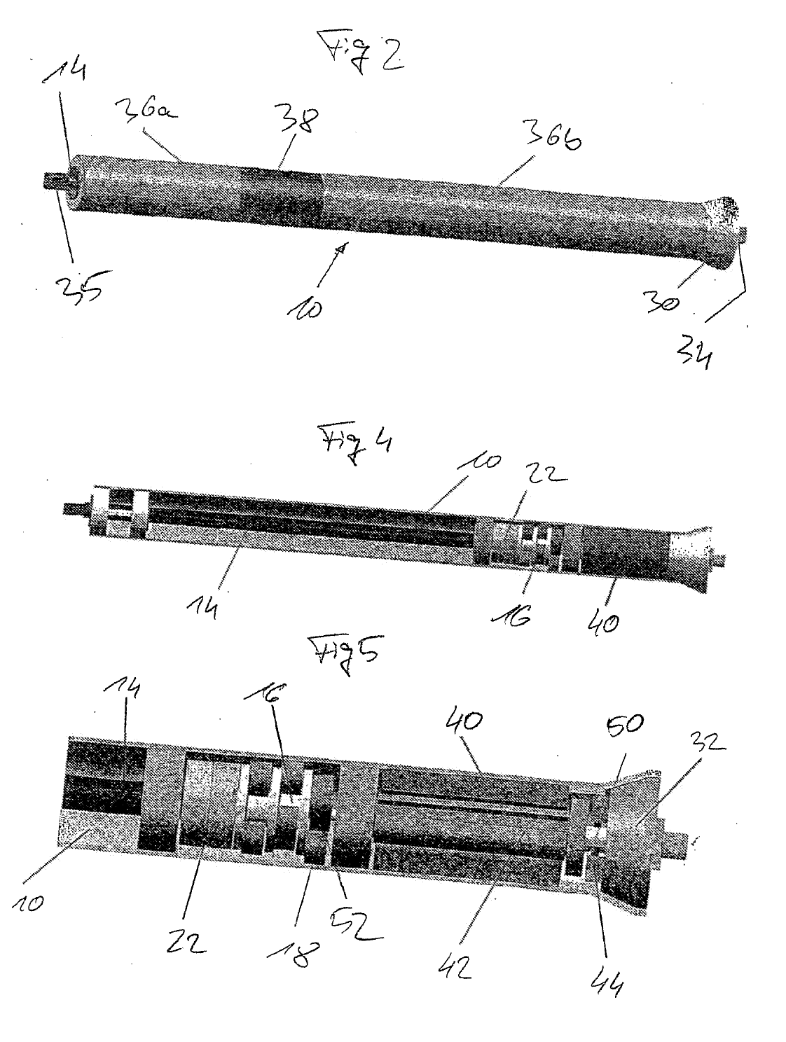

An alternative embodiment of the roller tube is shown in FIG. 3, the roller tube 10 shown there being made in one piece in contrast to the roller tube from FIG. 2. In this embodiment of the invention, the electric motor for driving the roller tube is inserted either completely with its housing into the roller tube 10 (the outside diameter of the housing, of course, having to be correspondingly smaller than the inside diameter of the roller tube) or an electric motor without its own housing is installed in the roller tube, the roller tube itself then assuming the housing function. The advantage of the latter embodiment is, on the one hand, the possibility of further reducing the outside diameter of the roller tube and on the other hand, increased stability as compared to a multi-piece roller tube. In turn in this case, the roller tube 10 is also rotated about the roller shaft 14 and the inner part 32 of the end cap.

FIG. 4 shows a shade arrangement with an electric motor which is located in the roller tube 10 and from which, in this view with the roller tube cut open, in turn, only one magnet 40 of the stator can be seen. In this connection, the electric motor is again installed in the roller tube 10—therefore, also the name “tube motor”—such that the roller tube assumes the function of the motor housing. Similar to the embodiment shown in FIG. 1, the electric motor is supported on the body-mounted roller shaft 14 via planetary gearing 16 and a slip clutch 22 via which it drives the roller tube 10 with which it is permanently connected in the region of the magnet 40. The connection of the electric motor to the body-mounted network, however, in this case, does not take place via flexible cables, but via sliding contacts, as will be explained in detail below.

FIG. 5 shows the shade arrangement from FIG. 1 in an enlarged partial view of the region of the magnet 40 of the driving electric motor 12. The magnet 40 is permanently connected to the roller tube 10, for example, by being cemented to the inside of the roller tube. The magnet 40 can also be formed of a plurality of magnets which are, in turn, attached on the inside of the roller tube 10. Within the magnet 40 which is shown here, in contrast to FIG. 4, an armature 42 turns and drives the planet wheels 18 of the first stage of the planetary gearing 16 via a sun wheel 52. Since current flows through the armature 42, which is shown schematically, in contrast to the magnet 40 of the electric motor which is a permanent magnet, a connection of the rotating anchor to the body-mounted power supply of the vehicle is required. This is ensured by a body-mounted brush system 44 which corresponds to the known brush systems of electric motors and is in sliding contact with the commutator 50 of the armature 42. Different from known tube motors for shade arrangements, here, the brush system 44, in addition to its function as a current transformer, is used as an armature-mounted commutator 50, and also, at the same time, to carry current from the body-mounted electrical system of the vehicle to the electric motor or tube motor which turns together with the roller tube 10. Thus, another sliding contact which would be necessary when using known electric motors becomes unnecessary. Altogether, in the drive unit of the shade arrangement from FIG. 5, on the one hand, the armature 42 turns within the magnet 40 with the engine rpm, and on the other hand, the magnet 40, together with the roller tube 10, turns relative to the body with a second rpm which differs from the motor rpm by the step-down ratio of the planetary gearing 16.

1-26. (canceled)

27. Shade arrangement for a motor vehicle with a drive unit which has a roller tube for taking up a length of shade material, a roller shaft and an electric motor for driving the roller tube around the roller shaft, and planetary gearing, wherein the roller tube has an inside surface that forms a ring gear of the planetary gearing.

28. Shade arrangement as claimed in claim 27, wherein a sun wheel of the planetary gearing is driven by the electric motor and output driving of the roller tube takes place via a planet carrier.

29. Shade arrangement as claimed in claim 27, wherein the planetary gearing is a multi-stage planetary gearing.

30. Shade arrangement as claimed in claim 29, wherein the planet carrier of a preceding gear stage is connected to a sun wheel of a following gear stage.

31. Shade arrangement as claimed in claim 29, wherein the inside surface of the roller tube forms a ring gear for each of the planetary gearing stages.

32. Shade arrangement for a motor vehicle as claimed in claim 27, wherein the electric motor has a stator and an armature, the stator being connected to the roller tube so as to turn with the roller tube, and the armature being supported to turn relative to a body of the motor vehicle when the roller tube turns, in an installed state of the shade arrangement in the motor vehicle, and wherein the electric motor has sliding contacts by means of which it is connected to a voltage source of the vehicle in said installed state.

33. Shade arrangement as claimed in claim 32, wherein the sliding contacts of the electric motor have a brush system which connects the voltage source to a commutator of the armature of the electric motor.

34. Shade arrangement for a motor vehicle claim 27, wherein the electric motor has a stator and an armature, the stator being connected to the roller tube to turn when the roller tube turns, and the armature being supported to turn relative to a body of the motor vehicle when the roller tube turns, in an installed state of the shade arrangement in the motor vehicle, wherein the electric motor is connected by means of flexible cables to a voltage source of the vehicle in said installed state, the cables having a length and flexibility sufficient to maintain, in an installed state of the shade arrangement in a motor vehicle, a connection to a voltage source of the vehicle even for a maximum degree of rotation of the electric motor between and fully extended and a fully wound up state of the shade material with respect to the roller tube.

35. Shade arrangement for a motor vehicle, preferably as claimed in claim 27, wherein a slip clutch is provided in a drive line of the roller tube.

36. Shade arrangement as claimed in claim 35, wherein the slip clutch comprises two clutch disks which are pretensioned into contact with one another.

37. Shade arrangement as claimed in claim 36, wherein the electric motor is supported against one of the two clutch disks and the other of the two clutch disks is connected to a body of a motor vehicle in an installed state of the shade arrangement in the motor vehicle.

38. Shade arrangement as claimed in claim 36, wherein the clutch disks are rotatable relative to one another upon application of a predetermined torque.

39. Shade arrangement as claimed in claim 27, wherein the roller tube is formed of a plurality of partial tubes which together with a housing of the electric motor form the roller tube.

40. Shade arrangement as claimed in claim 39, wherein the partial tubes are mounted on the electric motor.

41. Shade arrangement as claimed in claim 27, wherein the roller tube is made of a one piece construction and the electric motor is mounted within the roller tube.

42. Shade arrangement as claimed in claim 41, wherein the roller tube forms a housing of the electric motor.

43. Shade arrangement as claimed in claim 27, wherein the roller tube is connected on one end to an end cap which has an inner part which is rotatable relative to the roller tube and on an opposite end is connected to a body of a motor vehicle in an installed state of the shade arrangement in the motor vehicle.

44. Shade arrangement as claimed in claim 43, wherein the end cap has a cylindrical section on which the roller tube is disposed, and a conical cable drum which projects from the roller tube.

45. Shade arrangement as claimed in one of claim 43, wherein the roller shaft on the end of the roller tube opposite the end cap projects out of the roller tube and is supported on the body in said installed state.

46. Shade arrangement as claimed in claim 43, wherein the electric motor has a stator and an armature, the stator being connected to the roller tube so as to turn with the roller tube, and the armature being supported to turn relative to a body of the motor vehicle when the roller tube turns, in an installed state of the shade arrangement in the motor vehicle, wherein the electric motor has sliding contacts by means of which it is connected to a voltage source of the vehicle in said installed state; and wherein the sliding contacts are housed within the end cap.

47. Shade arrangement as claimed in claim 27, further comprising a sensor for detecting the rotational position of the roller tube.

48. Shade arrangement as claimed in claim 47, wherein the roller tube is connected on one end to an end cap which has an inner part which is rotatable relative to the roller tube and on an opposite end is connected to a body of a motor vehicle in an installed state of the shade arrangement in the motor vehicle, and wherein the sensor is housed within the end cap.

49. Shade arrangement as claimed in claim 27, wherein the electric motor is a tube motor that is housed completely within the roller tube.

50. Vehicle body with an at least partially transparent or translucent cover or window, and a shade arrangement having a shade with an extended position at least partially unwound from a roller tube in which the shade at least partially screens said cover or window, and a position wound-up on the roller tube exposing said cover or window, the shade arrangement further comprising a roller shaft, a planetary gearing and an electric motor for driving the roller tube around the roller shaft via the planetary gearing, wherein the roller tube has an inside surface that forms a ring gear of the planetary gearing.

51. Vehicle roof module with an openable roof opening which can be closed by means of an at least partially transparent or translucent cover and a shade arrangement having a shade with an extended position at least partially unwound from a roller tube in which the shade at least partially screens said, and a position wound-up on the roller tube exposing said cover, the shade arrangement further comprising a roller shaft, a planetary gearing and an electric motor for driving the roller tube around the roller shaft via the planetary gearing, wherein the roller tube has an inside surface that forms a ring gear of the planetary gearing.
